(19) United States
(12) Patent Application Publication
(10) Pub. No.: US 2024/0065810 A1
(43) Pub. Date: Feb. 29, 2024

(54) ORTHODONTIC BRACKET WITH ADJUSTABLE SLOT PRESCRIPTIONS

(71) Applicant: AYMAN MKHAIL ADIB, SHARJAH (AE)

(72) Inventor: AYMAN MKHAIL ADIB, SHARJAH (AE)

(21) Appl. No.: 17/893,200

(22) Filed: Aug. 23, 2022

(51) Int. Cl. A61C 7/28

(52) U.S. Cl. CPC A61C 7/28

(57) ABSTRACT

This invention is an orthodontic bracket with adjustable slot prescriptions in all directions of space while continuously attached to tooth surface. The disclosed bracket is composed of a base designed to be attached to tooth surface, a fixed portion linked to bracket base, and a movable portion containing bracket slot. The articulation between fixed and movable portions is ball-to-socket form. Both spherical ball and socket articulating surfaces have indentations that, when closed, engage in a firm and stable manner, and when open, allow free rotational and spherical movement to movable portion of bracket and the slot. The bracket slot can be adjusted to the desired prescriptions in one or all planes of space while it remains affixed to tooth surface, eliminating necessity of brackets change during treatment. It will lead to personalized treatment planning, shorter treatment duration, more precise and physiological forces applied to tooth and periodontal structures.

### FIELD OF INVENTION

The invention relates to orthodontic appliances, more particularly to orthodontic brackets. Orthodontics is a specialty in dentistry that aims to correct the position of misaligned teeth within surrounding bone structures by means of orthodontic appliances attached to patient teeth. Brackets are the main component of orthodontic fixed appliances, they contain wire passageway called bracket slot. The slot is the place of application of orthodontic forces generated by activation of orthodontic archwires. Brackets are available in several forms and in several dimensions and prescriptions of bracket slot. The prescriptions that are incorporated in slots are predetermined and designed, according to a variety of technics and philosophies, based on statistical measurements and average values, without taking in consideration each individualized type of malocclusion, tooth anatomy and morphology, or personalized treatment plan. These prescriptions are permanent and cannot be adjusted throughout progress and constant changes in tooth position at every stage of orthodontic treatment, this makes the direction and magnitude of orthodontic forces applied inside bracket slot, difficult to be accurate and subject to undesired secondary forces and moments. The ability to adjust bracket slot is of a major importance, when treatment progress and changes in tooth position impose changes in types and directions of applied forces. These slot adjustments should be easy to perform. Brackets slot adjustability leads to better control of tooth movement in any direction according to biomechanical rules for each individualized treatment plan, achieve more accurate teeth alignment, conserve health conditions of teeth and surrounding structures, therefore provide long-term stability of orthodontic treatment results.

### BACKGROUND OF INVENTION

Orthodontic treatment aims for correction of misaligned teeth in their surrounding bone structures to solve problems of malocclusion, skeletal and dental discrepancies, achieve good functional and aesthetical teeth alignment, enhance facial harmony, and provide beautiful smile. Clinicians dispose large variety of appliance types that follow several philosophies and technics. In orthodontic fixed appliances, brackets are the main element. Brackets are attached to teeth surfaces to provide a place of application of forces, these forces are transmitted to tooth and root surfaces to initiate the required tooth movement. Orthodontic brackets comprise a passageway, called bracket slot, designed to receive and accommodate one or more arch wires. The arch wire according to its type and activation, applies forces in one or more directions inside the walls of the slot, these forces are transmitted to tooth root according to physical and biomechanical rules, initiating physiological changes at tooth surrounding tissues leading to dental movement. Orthodontic wires are inserted inside brackets slots, then secured and ligated by means of different types of ligation, such as ligature wires or ligature rubber ties. Brackets may have self-ligating mechanism. The importance of ligation is to secure arch wire inside the slot to apply forces. Brackets Slot had been designed initially perpendicular to base of bracket with no specific prescriptions, this led practitioners to bend wires to compensate the variation of inclination of labial surface of each tooth, to avoid random application of unwanted forces when straight wires are applied. Then with evolution of orthodontic technics, slot prescriptions were added to allow straight wires pass in all brackets without applying unwanted forces. Brackets Slots are designed, predetermined and fabricated, according to average and statistical measurements and values. Clinicians usually choose the preferred prescriptions of bracket slot, according to treatment plan, biomechanical plan and sequences of forces application. These predetermined slot prescriptions remain unchanged throughout progress of treatment and cannot match constant changes in root position and biomechanical requirements and treatment plan reevaluation at different stages of treatment. During orthodontic treatment it becomes necessary to change magnitude and direction of forces applied inside bracket slots, this can be achieved by adding bends to arch wires, or frequent changes of arch wires type and sections and metallurgical characteristics, or by adding additional accessories to fixed appliance, and sometimes it becomes necessary to remove bracket then reattach it in a different or more accurate position in respect to tooth surface, sometimes due to biomechanical necessities, clinicians have to change brackets with other brackets of different prescriptions, on one tooth or on a group of teeth. All these require skills, additional treatment sessions, longer chair time, extra costs, causes unnecessary tooth movements due to undesired secondary forces with a potential impact on teeth and surrounding structures. Therefore it is of a great importance to have brackets with slot prescriptions that can be adjusted, in all planes of space, in a simple and easy manner, selectively on one tooth or a group of teeth at any stage of orthodontic treatment. The disclosed innovative bracket is a slot prescriptions adjustable bracket, in all planes of space as required, at any stage, and repeatedly throughout orthodontic treatment, while brackets remain affixed to tooth surface.

### General Description of Invention

Orthodontic treatment is usually initiated after performing a case study, a treatment plan and a biomechanical plan. Clinicians choose appropriate treatment technics to achieve treatment goals. Brackets slot prescriptions are basically chosen according to treatment objectives and biomechanics to be applied to achieve these goals. During orthodontic treatment, with progress in teeth movement, at different stages, the biomechanical plan is reevaluated to ensure movement of teeth and their roots meet the treatment goals. It is necessary to change and to adjust direction and magnitude of applied forces inside brackets slot at every stage of orthodontic treatment. Orthodontic applied forces move teeth in several directions taking in consideration the anatomy and root position of teeth in surrounding structures. Conventional brackets with predetermined prescriptions may include, according to different technics and philosophies, different values of prescriptions in slot size and measurement in respect to brackets base attached to tooth surface, in terms of tipping, angulation and torque, these values are specific and different to each tooth of upper and lower dental arches according to its anatomy and to its axial inclination of insertion in bone structures, and to its position in relation to adjacent and opposing teeth. These values are average and predetermined according to clinical, radiological, and statistical studies. Different technics suggest different values of brackets slot prescriptions that allow clinician to perform biomechanical treatment plan in an accurate manner, these values remain unchanged throughout different stages of treatment and do not take in consideration anatomical individual variations and constant changes in teeth position throughout progress of orthodontic treatment. During orthodontic treatment, with progress of teeth movement throughout sequences of treatment, modifications and adjustments of applied forces in magnitude and direction on brackets and inside their slot, become necessary to adapt forces to constant changes in teeth position inside their surrounding structures. From a biomechanical point of view, the point of application of orthodontic forces on and inside bracket slot, is at a distance from the center of resistance of tooth structure laying at a certain point of root surface, differentially for each tooth according to its anatomical shape and characteristics. The distance between the point of application of forces and the center of resistance of a tooth leads to fraction of forces into primary desired forces and moments, and secondary undesired forces and moments. It is of a major importance to control the applied orthodontic forces in order to conserve primary desired forces and moments, and to overcome and eliminate undesired secondary forces and moments, to ensure accurate and physiological tooth movements, and to conserve the health of teeth and surrounding structures. Bracket slot forms the place where forces are applied and through which forces are transmitted to tooth and root, therefore dimensions and prescriptions of bracket slots are of a major importance in the equation how forces are applied to achieve desired tooth movement, in one plane or two or three planes of space. In order to adjust and control magnitude and direction of forces, clinicians usually have to add bends to archwires, or frequently change wires with different metallurgical specifications or cross sections. In some cases they use additional accessories to fixed appliance, this may include additional wires or elastics or any type of accessories that generate forces to overcome secondary forces and moments emerging from application of forces. Clinician may in some cases need to detach bracket from tooth surface and reattach bracket in different position or replace it with a different bracket of different slot prescriptions to meet the constantly changing biomechanical considerations throughout orthodontic treatment. Conventional brackets of all types and slot prescriptions cannot be adjusted to every personalized treatment plan and objectives, therefore clinicians face challenges such as:
Placement of brackets on tooth surface in an accurate and precise position may be difficult especially on crowded and rotated teeth.
Frequent changes of wires and appliance elements.
High skills in bending and forming of archwires.
Extended long sessions on dental chair.
Excessive number of sessions.
Applied forces are difficult to be controlled in a progressive and physiological manner in terms of direction and magnitude because of secondary forces and moments arising differentially on each tooth.
Predetermined adjustable slot prescriptions are of average values and do not take into consideration personalized anatomical variations and individualization of treatment plan and objectives.
Long-term retention may be needed due to inaccurate teeth and roots alignment, to avoid relapse of orthodontic treatment.

The adjustable slot prescriptions brackets allow clinician to overcome all these challenges. Slot prescriptions can be adjusted in all planes of space, selectively on one tooth or a group of teeth, and repeatedly whenever adjustment is needed throughout all stages of treatment, to ensure total control and accuracy of applied forces, and elimination of undesired arising secondary forces and moments. This leads to high standard orthodontic treatment results functionally and esthetically, ensures long-term stability, and reduces duration of treatments. The disclosed invention presents an adjustable slot prescriptions orthodontic bracket, clinicians can adjust bracket slot at initiation of treatment according to technic they use and to individualized treatment plan objectives. They can personalize the biomechanical treatment plan, then throughout treatment progress, bracket prescriptions can be adjusted selectively on one tooth or a group teeth at all stages of treatment as sequences of treatment many require. The disclosed bracket is composed of three portions, base of bracket, fixed portion linked to base of bracket, and movable portion articulating with fixed portion. Fixed portion and movable portion are connected by indented spherical articulating surfaces in ball-to-socket form. Articulating surfaces have indentations that are projections on ball surface and depressions on socket surface. Indentations are engaged in lock position, ensuring a firm stability of movable portion, and are disengaged in unlock position, allowing spherical articulating ball to rotate freely. Base of bracket has posterior surface designed to be attached to a tooth surface, and anterior surface firmly attached to fixed portion. Fixed portion includes body of fixed portion which has a spherical indented hollow forming the socket of articulating mechanism, designed to receive the indented ball of movable portion. Fixed portion also includes sliding part that forms the top section of articulating socket and contains one or more projections passage to slide along opposing grooves passage at fixed portion linked to base of bracket. When sliding part moves upwards, it separates the spherical articulation socket and disengages indentations between spherical ball and spherical socket, this allows ball of movable portion to rotate freely, at the same time the ball remains stuck in its socket. The upwards movement of sliding surface is slightly greater than the size of indentations, which is enough to allow indentations disengagement. Fixed portion includes lock-unlock mechanism, this mechanism consists of a pin that passes through anterior face of sliding part to reach the posterior part of fixed portion. The pin contains a nail of a size slightly bigger than the size of indentations, the nail is accommodated inside sliding surface. When pin is rotated 90° clockwise the nail rotates and pushes sliding surface upwards, to gingival direction, separating the spherical articulating socket to a distance equals the size of nail, when pin is rotated back to initial position 90° counterclockwise, nail is rotated and it brings sliding surface downwards to initial lock position closing the articulating spherical socket and ensure total closure of socket and engagement of indentations between ball and socket articulating surfaces. At unlock position, disengagement of indentations allows free movement of spherical articulating ball of movable portion that contains bracket slot, at lock position engagement of indentations provides firm stability of spherical articulating ball at chosen adjusted slot prescriptions. Articulating spherical ball indentations cover all the surface of the ball except a part that extends out of articulating socket to allow a free rotational movement of articulating ball FIG. 10. When movable portion is on unlock position, slot can be adjusted and measured in respect to base of bracket attached to tooth surface, in corono-apical direction for torque movement, in mesio-distal direction for rotation movement, and clockwise-counterclockwise for tipping and uprighting movement. The adjustment can be in one direction or a combination of directions, in all planes of space. The ability of slot prescriptions adjustment at initiation of treatment or at any stage of treatment, selectively and repeatedly provides a solution for personalized treatment planning and biomechanical accuracy of applied forces. The ability of slot prescriptions adjustment makes forces applied to teeth more accurate and efficient, prevents unnecessary multiple root movements, conserves dental and periodontal tissues, allows tooth movements in ideal physiological conditions, and therefore long term stability of treatment results.

### BRIEF DESCRIPTION OF DRAWINGS

FIG. 1: Front view of bracket, (1) Movable portion including slot and ligation wings. (2) Fixed portion. (3) Base of bracket.

FIG. 2: Side view of bracket.

FIG. 3: Top view of bracket. (1) Movable portion. (2) Fixed portion including sliding part. (3) Base of bracket.

FIG. 4: Front, geometrical view, shows articulating spherical part and sliding grooves.

FIG. 5: Side, geometrical view, shows articulating spherical part, sliding grooves and lock-unlock pin.

FIG. 6: Top, geometrical view.

FIG. 7: Front view of bracket. (1) Movable portion includes, 12A upper ligation wing, 12B lower ligation wing, 13 Bracket slot. (2) Fixed portion of bracket, 23 sliding part, 24 Lock-unlock pin. (3) Bracket base, 31 body of bracket base.

FIG. 8: Side view of bracket. (1) Movable portion includes 15 non indented surface of articulating spherical ball. (2) Fixed portion, 22 sliding grooves, 23 sliding part. (3) Bracket base, 32 attachment surface with mesh.

FIG. 9: Top view of bracket.

FIG. 10: Front, geometrical, view of bracket. (1) Movable portion, 11 spherical articulating ball, 12A upper ligation wing, 12B lower ligation wing, 13 bracket slot, 14 Indentations of articulating ball, 15 non-indented surface of articulating ball. (2) Fixed portion, 22 sliding grooves, 23 sliding part, 24 lock-unlock pin, 25 Indentations of spherical articulating socket. (3) Bracket base, 31 body of bracket base.

FIG. 11: Side, geometrical view of bracket.

FIG. 12: Top, geometrical view of bracket

FIG. 13: Side view of bracket at movement in unlock position.

FIG. 14: Top view of bracket at movement in unlock position.

FIG. 15: Front, geometrical view of bracket at movement and angle range in both clockwise and counterclockwise directions, TIPPING, 2^{nd} order, pin unlocked.

FIG. 16: Side, geometrical view of bracket at movement and angle range in both upwards and downwards movements, TORQUE, 3^{rd} order, pin unlocked.

FIG. 17: Top, geometrical view of bracket at movement and angle range. In both mesial and distal directions, ROTATION, 2^{nd} order, around long axis of tooth, pin unlocked.

FIG. 18: Front view, side view, top view of bracket in lock position.

FIG. 19: Front view, side view, top view, geometrically, of movable portion and angle range of movements in all directions, in unlock position.

FIG. 20: Front view, side view, top view, of movable portion

FIG. 21: Front view, side view, top view of fixed portion of bracket in lock position.

FIG. 22: Side, geometrical, view of fixed portion in lock position.

FIG. 23: Top, geometrical, view of fixed portion in lock position.

FIG. 24: Top view of bracket.

FIG. 25: Side view of bracket.

FIG. 26: Front view of fixed portion and base of bracket.

FIG. 27: Side view of bracket in demonstrative open position.

FIG. 28: Fixed portion of bracket and indentations of articulating socket.

FIG. 29: Side view of bracket.

FIG. 30: Movable portion of bracket and indentations of articulating ball.

FIG. 31: Front view of bracket.

### DETAILED DESCRIPTION

Orthodontic bracket is the main element of the components of orthodontic fixed appliance, applied to most kinds of orthodontic treatments. Orthodontic bracket is affixed to tooth surface, its position on tooth surface is determined according to tooth anatomical characteristics and to position of the root of a tooth in the surrounding bone structures. Each tooth of a dental arch varies in anatomical shape of the crown and root, and in the position and inclination and size of the root inside the Alveolar bone. That is why there is a specific design of bracket and prescriptions of the slot of bracket for each tooth or group of teeth. Orthodontic bracket is affixed to most teeth on upper and lower dental arches as attachments on a tooth surface. Orthodontic forces may be applied on or inside brackets by means of any force generator mechanism, one of these mechanisms can be arch wires that are inserted inside the slot of brackets. Archwires have a variety of metallic compositions, cross sections, sizes and forms, in order to apply forces inside the bracket slot. These forces are applied and regulated in magnitude and in direction, according to desired teeth movements. The insertion of arch wire inside a bracket slot applies forces through bracket to tooth surface and root. Scientists created a variety of technics and philosophies to adapt brackets to the morphology of teeth surfaces and roots physiological inclinations, based on their anatomical characteristics and shapes, in a way that forces can be transmitted through brackets to roots and surrounding structures, in all planes of space. Application of forces to teeth by insertion of arch wires inside brackets slot should take into consideration rules of physics and biomechanics, in order to generate forces that perform accurate tooth movements. To do so, clinicians perform a precise biomechanical plan, selection of types of forces, choose suitable values of slot prescriptions, appropriate metallurgic specifications and cross sections of wires, add bends to wires to generate precise magnitude and direction of forces.

Forces are applied inside the slot of brackets at a distance from the center of resistance of tooth laying at the root, this leads to fraction of applied forces into primary desired forces and secondary undesired forces. To combat the undesired secondary forces which cause unwanted secondary tooth movements, clinicians have to apply additional forces that counter the unwanted secondary forces, by adding auxiliaries to appliance and bends to wires, even repeating teeth movement in a go and come manner to overcome these unwanted tooth movements. All these require efforts, skills, and it is time consuming, and may have an impact on roots and surroundings structures. Brackets are designed and developed to receive wires that generate forces in three planes of space, which are transmitted randomly to roots according to their initial malposition inside alveolar bone. The reason why predetermined prescriptions are added to slot, is to overcome the unwanted secondary forces, and to direct wires inside slot in a way that respects each tooth characteristics. But still to eliminate undesired secondary forces, clinicians have to bend wires frequently, change wire types and cross sections, and change brackets positions in respect to tooth surface throughout progress of treatment. Based on individualized treatment plan and objectives, the initial position of brackets on teeth surfaces needs readjustment in one or more planes of space at a certain phase of treatment, on a specific tooth or on a group of teeth. Regardless of technics, the readjustments can be done to conventional brackets, only by bending of wires and adding auxiliaries to appliance or even frequent debonding and rebonding of bracket to change its position on tooth surface. To control tooth movements precisely in all planes of space, clinicians have to consistently change brackets position on tooth surface or change brackets prescriptions by replacing brackets, and perform additional activations of arch wires in order to control directions of forces to overcome unwanted secondary forces, when any kind of predetermined slot prescriptions of brackets is used. Orthodontic wires can be of a variety of metallurgic compositions and specifications, they can have round or square or rectangular cross sections, clinicians choose different types of wires at different stages of treatment according to magnitude and direction of forces needed to perform a certain type of tooth movement that is consistently variable on each tooth or group of teeth of dental arch throughout treatment. Magnitude and direction of forces applied inside brackets slot, are transmitted to roots and surrounding structures, which lead to tooth movement according to physiological and cellular response to these forces. Teeth movement throughout orthodontic treatment is constant and multi directional in the three planes of space. The initial positioning of bracket on tooth surface and prescriptions of slot, are major factors to determine directions and types of root movements, as brackets slots receive applied forces as a point of application of forces, then transmit these forces to roots inserted in alveolar bone. Teeth movement directions are directly related to position, size, and prescriptions of slots in respect to bracket base attached to tooth surface. In this embodiment of adjustable bracket slot invention, slot prescription can be easily adjusted in the three planes of space, at any stage of orthodontic treatment, on one tooth or a group of teeth, by moving sliding part of fixed portion of bracket to unlock position, disengaging the movable portion that contains the slot of bracket. A spherical movement ability of movable portion will allow adjustment of slot prescriptions gradually and repeatedly, then moving sliding part back to its lock position provides firm affixing of the slot at the desired adjusted prescriptions. This bracket slot Adjustability minimizes the need of frequent changes and bending of wires, and the need of repositioning brackets on tooth surfaces, it also saves time and efforts and shortens chair time sessions, reduces impact of forces on roots and surrounding structures, shortens overall duration of treatment. Orthodontic treatment planning become more personalized and more accurate, and most of all more stable results can be achieved. The presented innovation is a bracket with adjustable slot, which is composed of three portions, FIG. 2, (3) Base of bracket, (2) Fixed portion of bracket, containing lock-unlock mechanism, and spherical articulation socket, and sliding part. (1) Movable portion of bracket, contains spherical articulation ball and bracket slot.

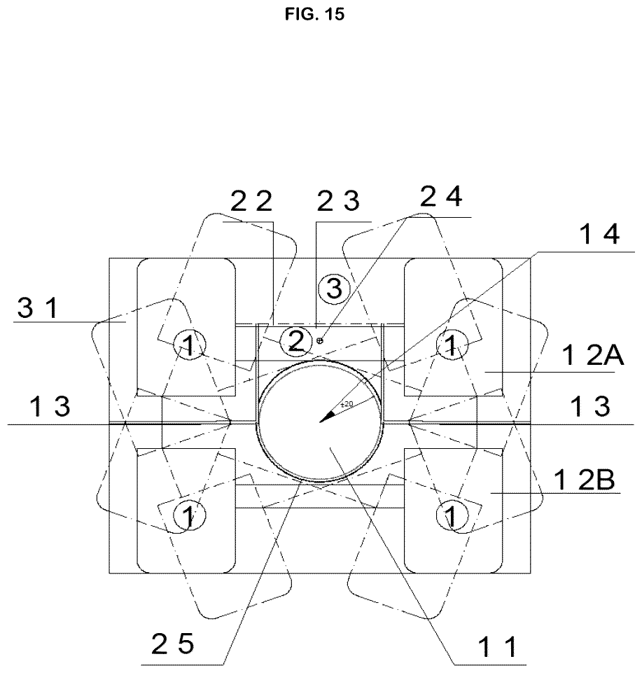

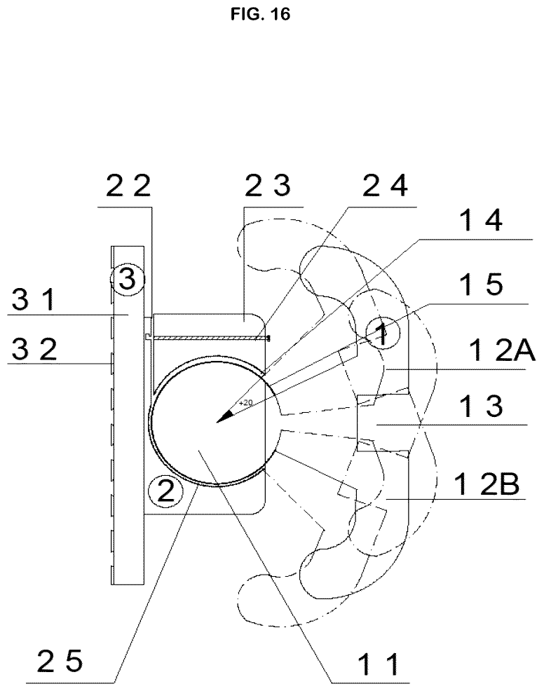

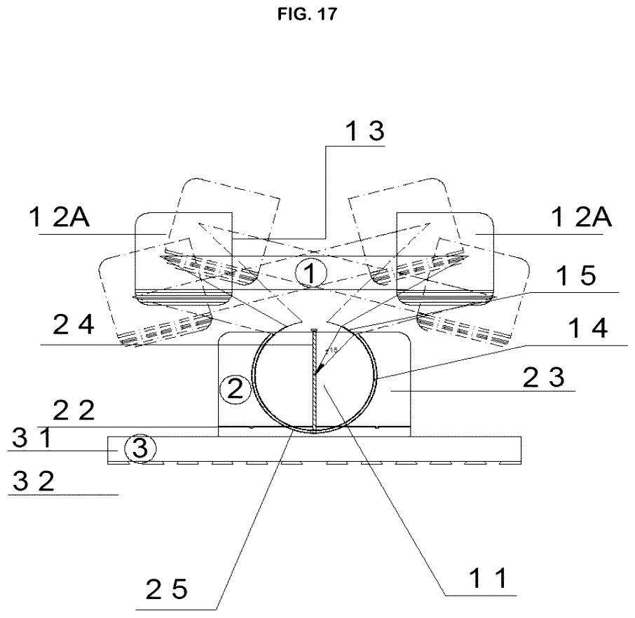

In FIG. 15, FIG. 16, FIG. 17, The sliding surface of fixed portion of bracket can be pushed in gingival direction by turning the lock-unlock pin 90 degrees clockwise to unlock Position, this rotates the nail linked to pin and pushes up the sliding surface. As sliding surface moves upwards, it separates the articulation socket and disengages the indentations between spherical articulating surfaces of ball and socket, allowing movable portion to rotate freely in all directions and planes of space. Clinician adjust bracket slot to desired prescriptions in respect to bracket base and aimed tooth movement directions. Once slot prescriptions are adjusted at required values, lock-unlock pin can be turned reversely, 90° counterclockwise pushing down sliding surface of fixed portion of bracket to lock position, which closes the articulation socket parts and engages the indentations of the ball and socket spherical articulating surfaces, locking the movable portion of bracket in a firmly stable position. This adjustment can be performed to one specific tooth or to a group of teeth, repeatedly at any stage of treatment, according to treatment progress, in a simple and time saving manner. Generally, when using conventional brackets, in order to adjust direction of movement to a specific tooth or a group of teeth, clinicians need to do bending on wires or to add auxiliaries to fixed appliance, or even change the position of bracket on the tooth by debonding bracket and rebonding it, or use different brackets with different prescriptions, in a different position in respect to tooth surface. All these actions are performed to change amount and direction of applied orthodontic forces, according to biomechanical and physics rules, to achieve accurate tooth movements. The act of insertion of wires inside the bracket slot that initiates orthodontic forces. It is according to type and section of wires, to how wires are engaged inside brackets slots and what prescriptions slots have, that forces are transmitted through brackets to tooth structures, including root surface. Adjustable slot brackets make the relation between wires and slots fully controlled by clinicians, throughout treatment and leads to better control of tooth movements. Teeth movements become more accurate, causing less damage to roots and surrounding structures. Clinicians can achieve better roots alignment in respect to bone structures and to occlusion considerations, and long-term stability leading to less relapse, things that all orthodontists are aiming to achieve for their patients. Adjustment of bracket slot prescriptions may be required in several cases such as:
Initial bonding of bracket on tooth surface is not accurate.
In cases of severe crowding when rotations of teeth make it difficult to position brackets at the exact position on tooth surface.
While application of forces, secondary forces arise leading to undesired secondary teeth movements. To combat these secondary movements, several acts should be taken, such as wires bends, adding of auxiliaries to fixed appliances, or frequent repositioning of brackets on teeth surfaces.
Orthodontic treatment plan is subject to reevaluation and modification throughout progress of treatment, this is why frequent revising of bracket slot prescriptions may be needed to produce variable forces in magnitude and direction on one tooth or a group of teeth at any stage of treatment.

From a biomechanical point of view, the force application point inside the bracket slot is at a distance from center of resistance of tooth structure laying at different point at the root of each tooth, according to its anatomy. To control a tooth or a group of teeth movement, forces and moments created by activation of a certain wire, should be calculated according to biomechanical rules. Adjustable slot prescriptions would be of a great benefit to achieve an accurate tooth movement by enhancing primary forces and minimizing arise of secondary forces. Conventional brackets are designed in all technics and philosophies, according to statistics and average values, in a way that tipping and torque angels and sizes of slot match the anatomy of tooth surface and root angulation and position inside the alveolar bone.

All these values do not take into consideration individual variations, and may be suitable for a specific treatment plan at a certain stage of treatment, but not for all treatment plans and all stages throughout progress of treatment. This is the reason why a vast variety of slot prescriptions and sizes exist, according to treatment philosophies and technics. All these issues make orthodontic treatment more complicated, requires skills and time consuming they make teeth subject to undesired secondary movements due to undesired secondary forces, and may have a serious impact on teeth and surrounding structures, especially when roots move unnecessarily and frequently from position to another in order to align teeth in ideal position and achieve long-term stability of treatment results.

This presentation of innovative slot adjustable bracket came up to make orthodontic treatment more accurate and successful. The adjustable bracket is affixed to a tooth surface, clinician adjust slot of bracket on each tooth in all planes of space to match tooth anatomical characteristics, initial position and inclination of tooth, and the biomechanical plan and technic he wants to follow for each individual case.

Forces are applied by means of arch wires or by any other means inside the bracket slot, these forces are transmitted to tooth root and surrounding structures, the surrounding structures respond by specific cellular and physiological changes leading to tooth movement.

Tooth movement is a response to applied forces. Magnitude and direction of applied forces will determine direction and amount of tooth movement according to biomechanical rules. In order to control this movement as desired, adjusting the slot of bracket in one or all planes of spaces would be very helpful to move the point of application of forces inside the slot to be at nearest point to center of resistance of tooth structures, or to any point, as tooth movement requires in any plane of space. This will allow full control of forces and moments applied to teeth structures. It is the fact of controlling the distance between point of application of forces and the center of resistance of a tooth to the desired location that can allow full control of type of movement, and elimination of undesired secondary forces that lead to undesired tooth movement.

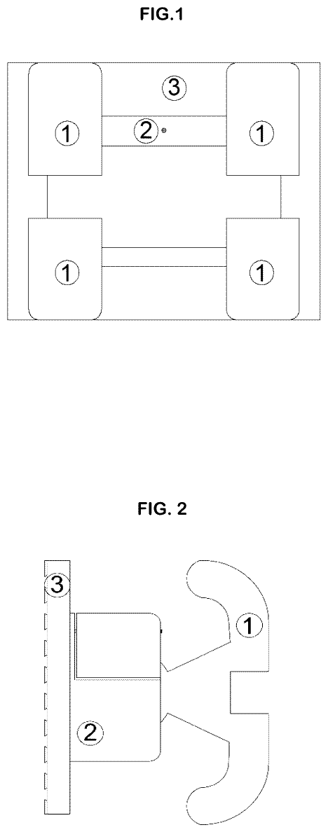

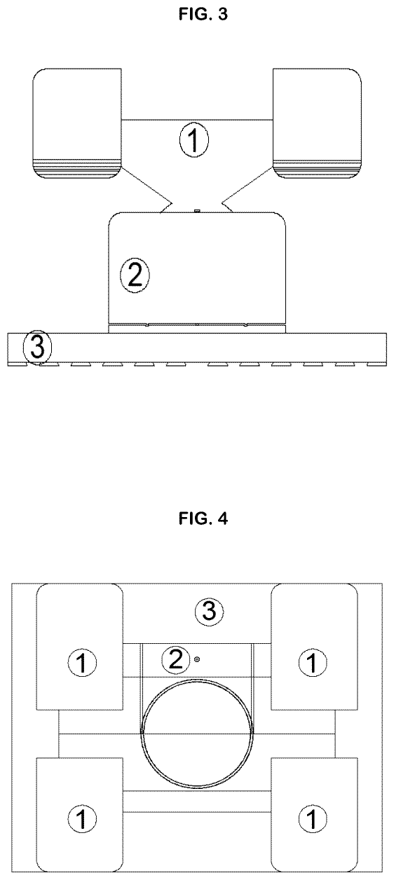

FIG. 1, FIG. 2, FIG. 3, show bracket in front view, side view, and top view, respectively.
(1) Movable portion of bracket.
(2) Fixed portion of bracket.
(3) Base of bracket.

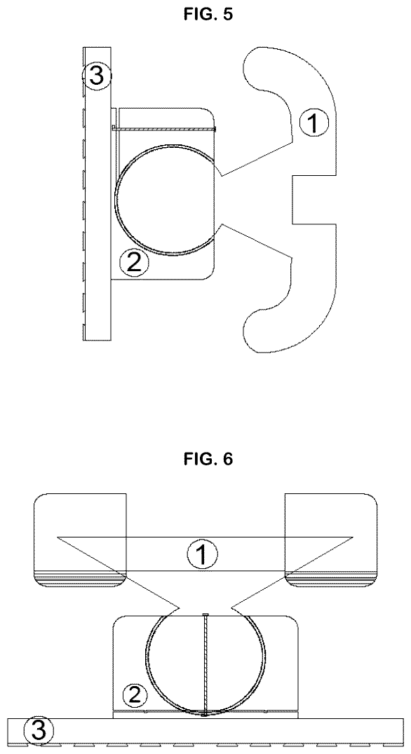

FIG. 4, FIG. 5, FIG. 6, show, geometrically, front view, side view, top view, respectively, of the components of the bracket.
(1) Movable portion of bracket.
(2) Fixed portion of bracket.
(3) Base of bracket.

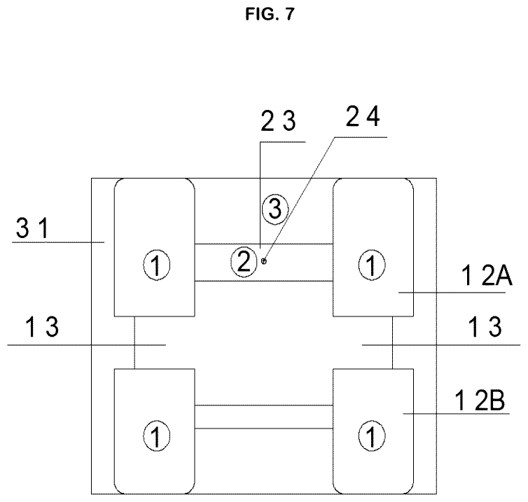

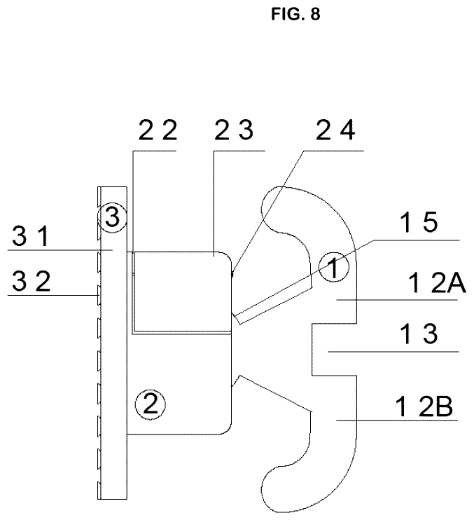

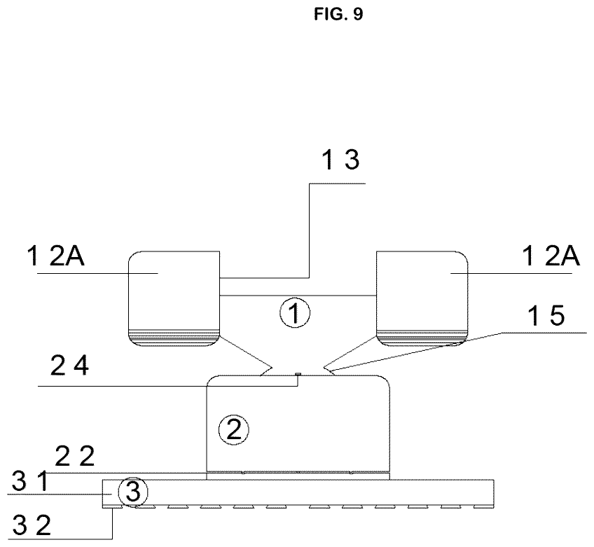

FIG. 7, FIG. 8, FIG. 9, show, spherical articulation mechanism, sliding grooves and projections channels, lock-unlock mechanism.

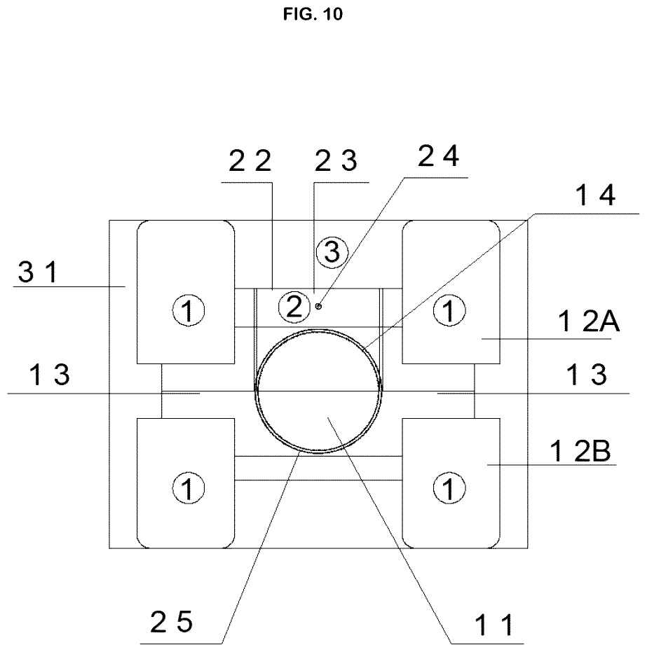

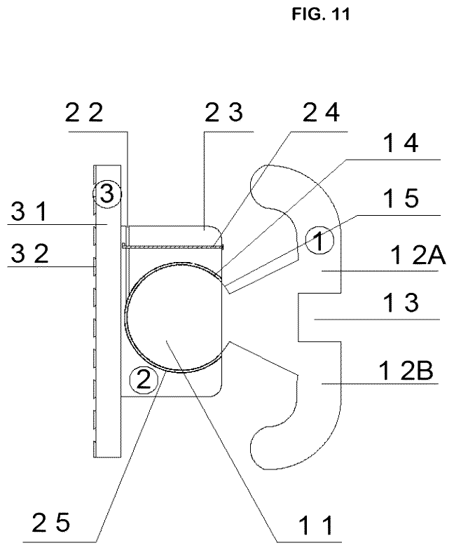

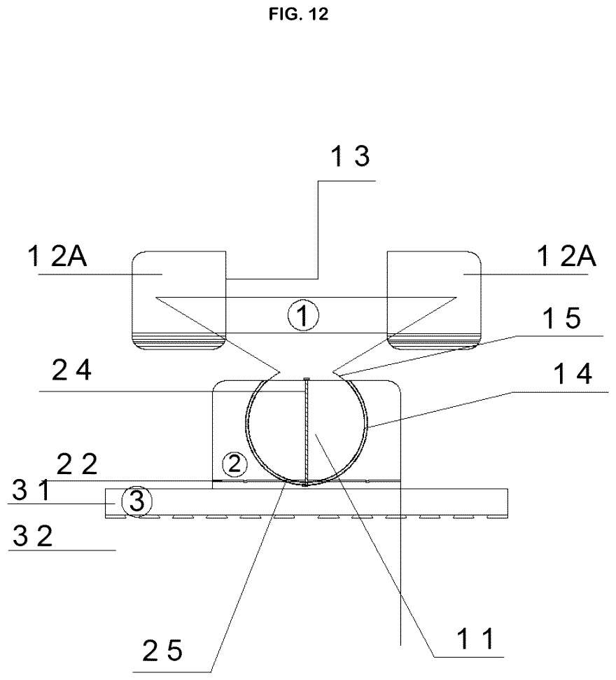

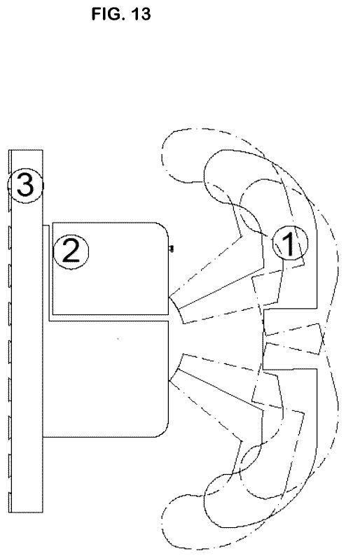

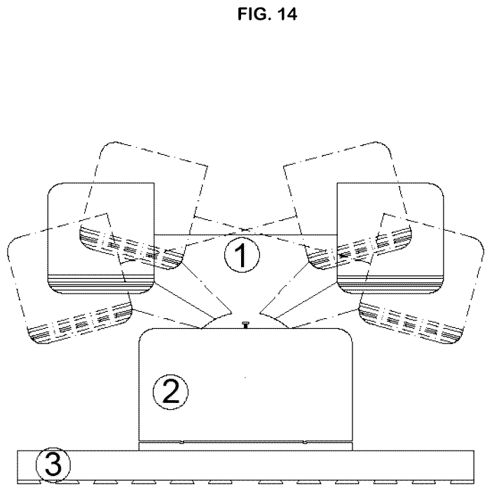

FIG. 10, FIG. 11, FIG. 12, show, geometrically, front view, side view, top view, respectively, of all components of the bracket.
(1) Movable portion of bracket.
11: Ball of spherical articulating mechanism.
12A: Upper ligation wings.
12B: lower ligation wings.
13: Bracket slot.
14: Indentations of spherical articulating ball surface.
15: None indented surface of spherical articulating ball.
(2) Fixed portion of bracket.
21: Fixed part of fixed portion of bracket.
22: Sliding grooves and projections channels.
23: Sliding part of fixed portion of bracket.
24: Lock-unlock pin.
25: Indentations of spherical articulating socket surface of fixed portion of
bracket.
(3) Bracket base:
31: Body of bracket base.
32: Attachment surface and its mesh.

During progress of orthodontic treatment and according to treatment goals, clinicians require frequent changes in amount and direction of applied forces and teeth movements. This may be required to one specific tooth or a group of teeth, to achieve accurate and stable alignment of roots in the surrounding bone structures in the three planes of space.

Lock-unlock pin (24) has a screw shape head and body containing a nail engaged inside the Sliding part of fixed portion of bracket, when pin is turned 90° clockwise, nail turns and pushes up the sliding part (23), sliding on projections and grooves (22), between the two surfaces. As the sliding part is open, separation of spherical socket and disengagement of indentations between spherical articulation socket and ball takes place, this makes the movable portion that contains the slot, free to rotate in all directions, at the same time the articulation ball stays held and stuck inside the articulation socket. Clinician can adjust the slot to any desired prescriptions, at the initiation, or at any stage of orthodontic treatment, as frequently as it is required.

FIG. 15, FIG. 16, FIG. 17, Show, geometrical, front view, side view, top view, respectively.

Front view shows slot adjustability clockwise and counterclockwise, in a range of ∓20°, this changes tipping angulation to direct roots movement in mesial or distal directions.

Side view shows slot adjustability upwards and downwards in a range of ∓20°, this change torque angulation to direct roots in labial or palatal (lingual) directions.

Top view shows slot adjustability in mesial or distal direction in range of ∓15°, this changes rotation of roots along their longitudinal axis.

The adjustment of slot prescriptions can be done in a greater range of angulations, if it is performed repeatedly, after each movement took place. As well as, slot adjustment can be done selectively in one direction at a time or a combination of directions in the three planes of space at each time, as required. Once bracket slot prescriptions adjusted, pin is turned back 90° counterclockwise, the nail pushes down the sliding part of fixed portion of bracket to lock position, closure of articulating socket and engagement of indentations of spherical articulations ball and socket takes place, the movable portion of bracket with its slot becomes firmly fixed.

Description of adjustability of slot presented here in FIGS. 15, 16, 17,
(1) Movable portion of bracket
11: Spherical articulation ball
12A: Upper ligation wings
12B: Lower ligation wings
13: Bracket slot
14: Indentations of spherical articulation ball.
15: None indented surface of spherical articulation ball.
(2) Fixed portion of bracket.
21: Fixed part of fixed portion
22: Sliding channels and grooves
23: Sliding part, at open position
24: Lock-unlock pin
25: Indentations of spherical articulation socket.
(3) Bracket base:
31: Bracket base body.
32: Tooth attachment surface of bracket with its mesh.

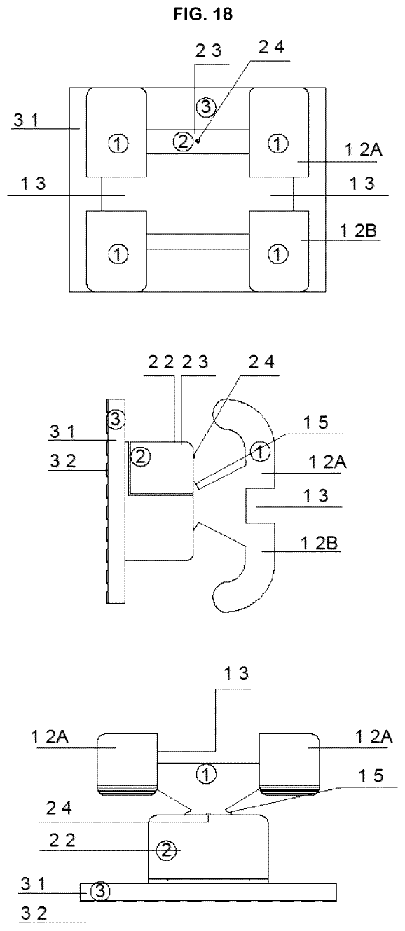

FIG. 18, Shows, bracket from all sides.

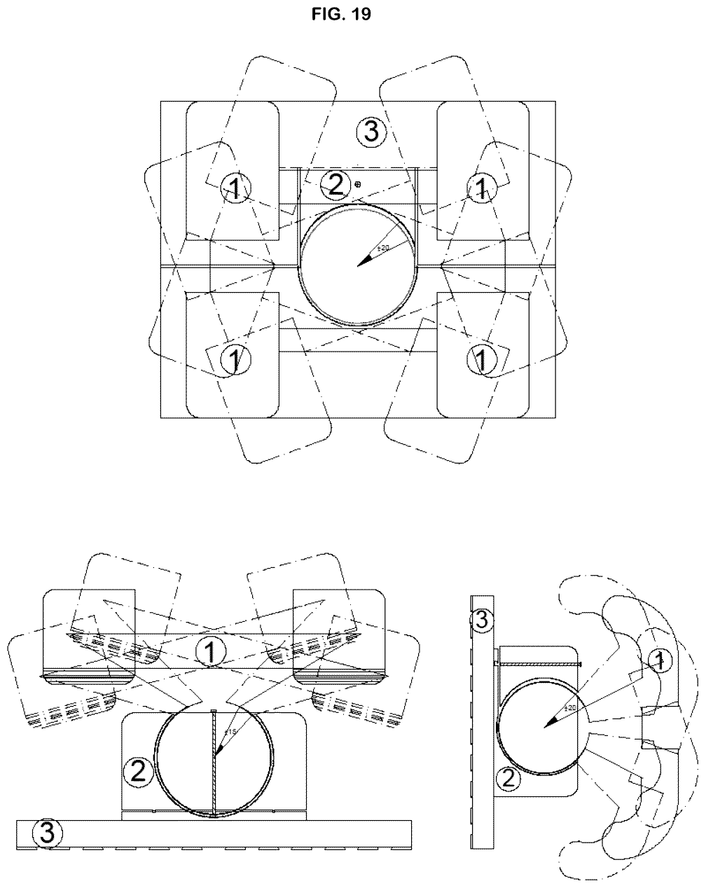

FIG. 19, Show, geometrical, front view, side view, top view, of bracket in unlock position and range of movement of slot in all directions.

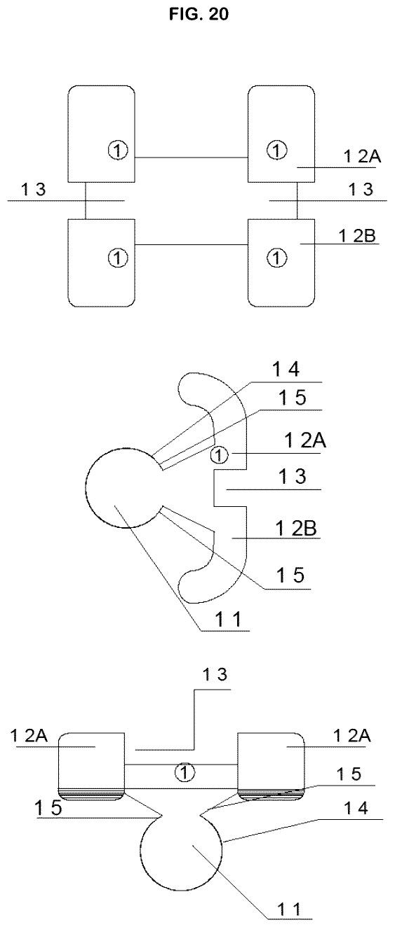

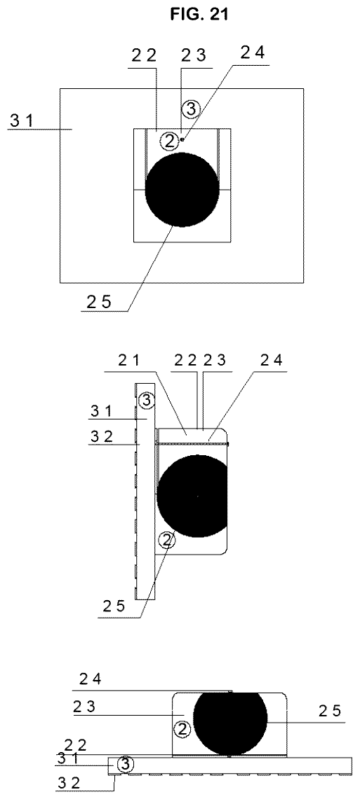

FIG. 20, Show, front view, side view, top view, respectively, of movable portion of bracket.
(1) Movable portion of bracket.
11: Spherical articulation ball.
12A: Upper wings.
12B: Lower wings.
13: Slot.
14: Indentations of spherical articulation ball.
15: None indented surface of spherical articulation ball.

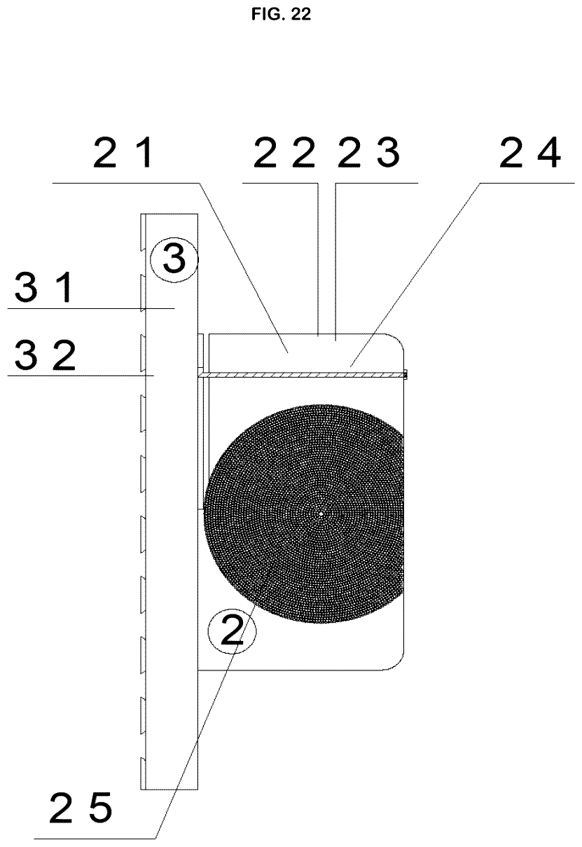

FIG. 22, show, geometrical, front view, side view, top view, respectively, of fixed portion in lock position.

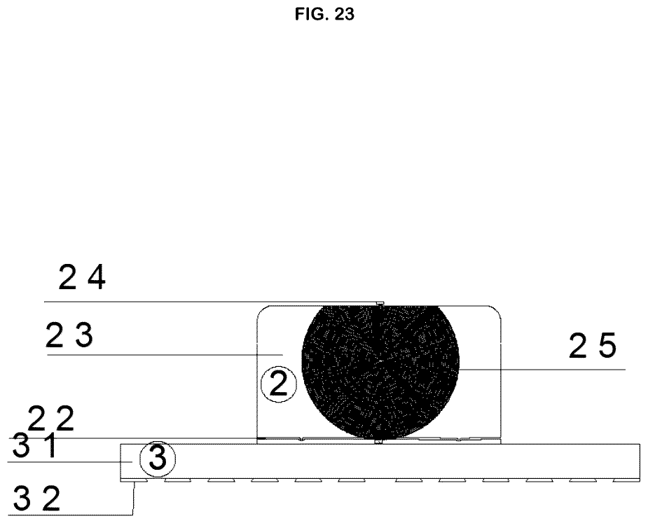

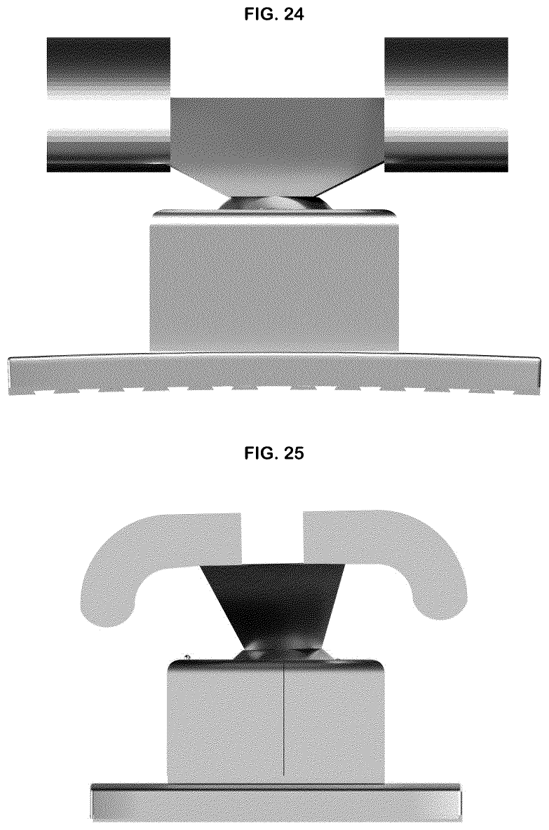

FIG. 23, FIG. 24, show, geometrical, side view, top view, respectively, of fixed portion of bracket.

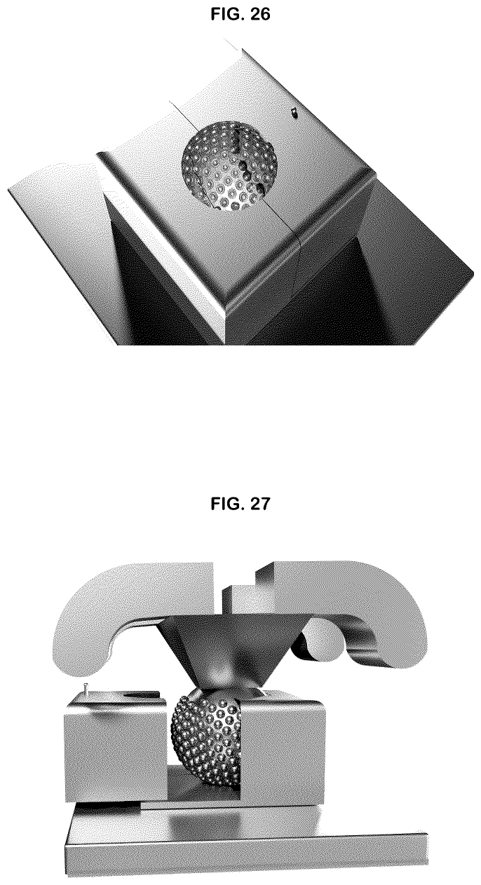

FIG. 25, FIG. 26, show, top and side view of bracket.

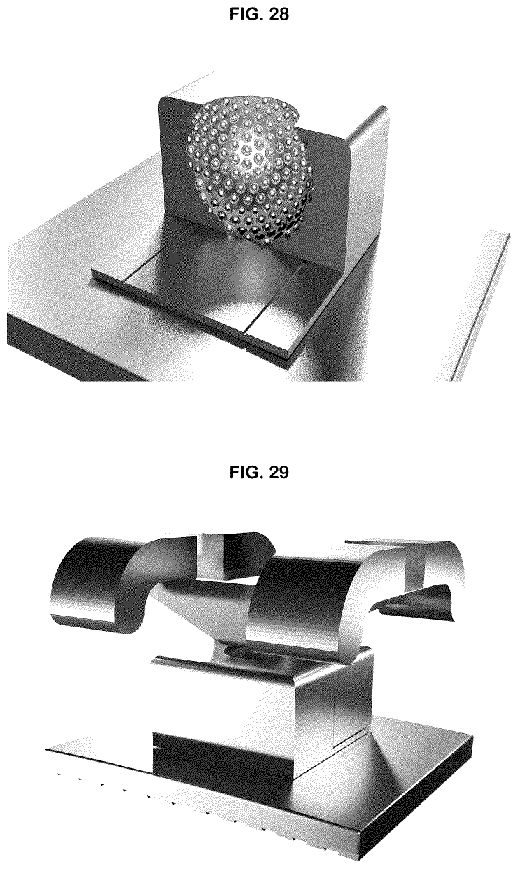

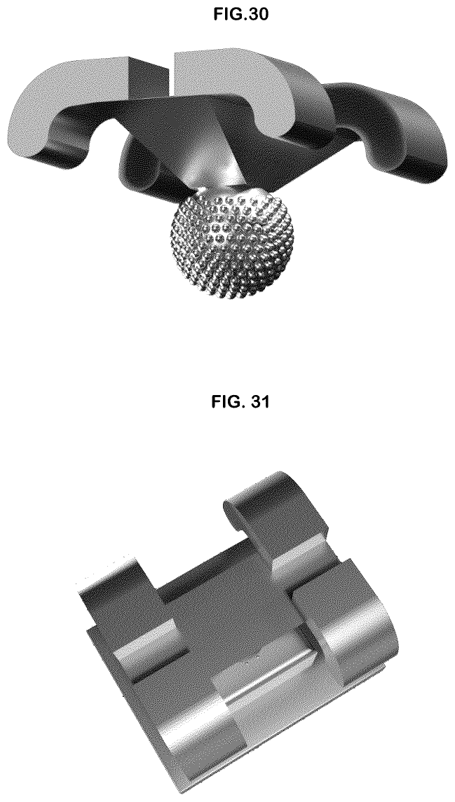

FIG. 27, FIG. 28, FIG. 29, FIG. 30, FIG. 31, show bracket and components, in 3D illustrations.

The disclosed bracket, can be designed and fabricated as buccal or lingual attachments and molar tubes, to match all kind of slot prescriptions, sizes and technics, in height and depth of slot, to accommodate one or more wires. The disclosed bracket can be fabricated of any metal alloy, ceramic material, or any suitable material that allow the appropriate function of bracket as an element of fixed orthodontic appliance.

The disclosed bracket can be regular in terms of ligation of wire or wires inside slot, or can be self-ligating by adding a slot closing mechanism.

1. Adjustable slot prescriptions orthodontic bracket, comprising a bracket base configured to be attached to a tooth surface, a fixed portion, a movable portion, and a lock-unlock mechanism. The movable portion which contains bracket slot can be individually, selectively and repeatedly adjusted to any specifications values in respect to bracket base, as desired by clinicians, in all planes of space, according to technic they use and to treatment plan, allowing control of magnitude and direction of applied forces, on or inside bracket slot, while bracket is constantly attached to tooth surface.

2. Adjustable slot prescriptions orthodontic bracket, comprising an articulation mechanism, composed of a spherical articulation ball linked to movable portion of bracket that contains the slot, the ball surface covered with prominent or grooved indentations, and a spherical articulation socket covered with grooved or prominent indentations to receive and contain the ball indentations, the socket is linked to fixed portion of bracket. The movement of articulating ball is rotational in all directions.

3. Adjustable slot prescriptions orthodontic bracket, comprising lock-unlock mechanism. The lock-unlock mechanism includes a rotatable pin containing a nail at its end inside the sliding part of fixed portion. When pin is rotated 90° clockwise, the nail turns and pushes the sliding part upwards (gingival direction), causing separation of spherical socket located in fixed portion of bracket and disengagement between indentations of ball and indentations of socket, to a distance slightly exceeding the size of indentations, this allows spherical ball to remain stuck inside spherical socket while it moves freely in all planes of space. When pin is rotated 90° counterclockwise, the nail turns back and pushes the sliding part downwards (occlusal direction) to lock position, causing closure of socket and a complete engagement between indentations of ball and socket, providing firm stability of movable portion of bracket and its slot.

4. Adjustable slot prescriptions orthodontic bracket, according to claim 2, comprising a movable portion that contains bracket slot and a spherical articulating ball covered with prominent indentations.

5. Adjustable slot prescriptions orthodontic bracket, according to claim 2, comprising a fixed portion linked to body of bracket that contains a spherical articulating socket covered with grooved or prominent indentations that match and fit the indentations of articulating ball. This fixed portion can be separated in unlock position and firmly closed in lock position.

6. Adjustable slot prescriptions orthodontic bracket, according to claim 5, comprising a sliding part linked to fixed portion of bracket, containing at least one projection to slide along opposed groove on fixed part of fixed portion of bracket. The sliding part slides upwards (gingival direction) at unlock position and downwards (occlusal direction) at lock position.

7. Adjustable slot prescriptions orthodontic bracket, according to claim 3, comprising lock-unlock mechanism. The lock-unlock mechanism includes a rotatable pin containing an extension at its ending inside sliding part of fixed portion; the extension may have the shape of a nail. When pin is rotated 90° clockwise, the nail turns and pushes the sliding part of fixed portion upwards to unlock position, causing limited separation of spherical socket and therefore disengagement of indentations between spherical ball and spherical socket. This separation of spherical socket is limited to nail size which is slightly larger than size of indentations. This allows the articulation ball and slot to move freely in all planes of space to a limit amount of angels of range of movements, which can be increased by repetition of adjustments after movement of tooth is achieved, in one plane of space or combination of two or more planes of space. After every adjustment of slot, pin is rotated 90° counterclockwise and the nail pushes the sliding part downwards to lock position, causing complete closure of spherical articulating socket and engagement of grooved indentations of socket with its antagonist prominent indentations of spherical ball, ensuring firm stability of ball and slot at adjusted prescriptions. This lock-unlock mechanism can be used as many times as needed to perform selective slot prescriptions adjustments, at any phase of orthodontic treatment.

8. Adjustable prescriptions bracket according to claim 1, may be fabricated of any metal alloy, or ceramic or transparent material.

9. Adjustable prescriptions bracket according to claim 1, concept and design can be applied to all kind of orthodontic attachments, such as lingual attachments and buccal or lingual tubes.

10. Adjustable prescription bracket, may have a component linked to bracket to act as slot cover for self-ligation.
